(19) United States
(12) Patent Application Publication
(10) Pub. No.: US 2007/0181199 A1
(43) Pub. Date: Aug. 9, 2007

(54) Hydraulic accumulator

(76) Inventor: Norbert Weber, Sulzbach/Saar (DE)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/588,821

(22) PCT Filed: Mar. 9, 2005
(86) PCT No.: PCT/EP05/02458

§ 371 Date: Aug. 9, 2006

(30) Foreign Application Priority Data
Apr. 16, 2004 (DE) 10 2004 018 456.9

(51) Int. Cl. F16L 55/04

(52) U.S. Cl. 138/31; 138/30

(57) ABSTRACT

The invention relates to a hydraulic accumulator with an accumulator housing provided in the form of a tube (1), inside of which a separating element, preferably a piston (9), which can be displaced in the axial direction (7) of the tube, separates pressure chambers (13, 15) located on either side of the separating piston. In addition, the tube (1) is closed at at least one end by a cover-like closing part (5) having a contact surface for joining to the respective end edge of the tube (1). The contact surface has a flat part provided in the form of an annular surface (39), which projects inside the tube (1) and which serves to positively brace the tube wall against radial forces, and the contact surface has an annular surface (41), which extends in a radial direction and which serves to positively brace the tube wall against axial forces.

The invention relates to an hydraulic accumulator having an accumulator housing in the form of a tube in which a separating element movable in the axial direction of the tube, preferably a separating piston, separates adjacent pressure compartments from each other on both sides.

Hydraulic accumulators of this type are commercially available and are used in hydraulic installations for a variety of applications. They are used among other things for energy storage, emergency actuation, for force equilibrium, for damping pressure surges, for pulsation damping, vehicle spring suspension, recovery of braking energy, and the like. Because of the variety of potential applications requiring hydraulic accumulators in large numbers, an effort is to be made to develop a design permitting simple, cost-effective production of reliably operating hydraulic accumulators.

The object of the invention accordingly is to provide a hydraulic accumulator characterized by reliability in operation, but one produced with low consumption of materials, that is, one light in weight, and with low manufacturing costs.

It is claimed for the first aspect of the invention that this object is attained by means of a hydraulic accumulator having the characteristics specified in claim 1 in its entirety.

In that, as specified in the characterizing part of claim 1, there are formed on the cover-like sealing component annular surfaces such that the adjoining end edge of the tube forming the accumulator housing is reinforced with positive locking against both the radial forces acting on the point of connection to the cover-like sealing component and against axial forces, sealing of the tube end especially stable in shape of the accumulator housing with the lowest possible consumption of materials and at a correspondingly low manufacturing cost is possible. The invention thus makes available a hydraulic accumulator which ensures reliability of operation along with low production costs.

In especially advantageous exemplary embodiments the sealing component is in the form of a plate having an annular bead which projects into the interior of the tube and is provided on the radially exterior flank of its projecting convexity with annular surfaces forming the bearing surfaces. A corrugated configuration of the plate such as this, produced simply and efficiently by cold molding, for example, results in a very favorable process of flux of force in introduction of the forces acting on the connecting point between tube wall and plate.

This results in particular in favorable relationships for bonding of the weld seam of the wall of the tube to the radially exterior flank of the annular bead.

Particularly favorable use of materials is achieved in the exemplary embodiments in which the annular bead of the plate is arched outward by cold extrusion molding from the plane of the plate. While the thickness of the material of the plate is reduced slightly in the area of curvature as a result of stretching, the thickness of the material of the plate remains unchanged in the level areas adjoining the curvature on both sides, so that the full thickness of the material in which the plate has through bores remains available to advantage. For example, there may be a connecting opening positioned in the center of the plate as access to the adjoining pressure compartment or fastening holes provided in lateral extensions of the plate, which extensions form flange components.

The object of the invention indicated in the foregoing, that of producing a lightweight hydraulic accumulator with low consumption of materials, but one which nevertheless is reliable in operation, is attained in another aspect of the invention by means of a hydraulic accumulator having the characteristics specified in claim 2 in its entirety.

The configuration claimed for the invention of a curved projecting dome in the center of the end part of the accumulator housing results in reinforcement of the end part. The risk of compromise of stability of shape by expansion and tension is thus reduced, so that the prerequisites for lightness of structure of the hydraulic accumulator are created, something which results in the desired reduction of costs of material and accordingly of the overall production costs.

The invention will be described in detail in what follows on the basis of an exemplary embodiment shown in the drawing, in which

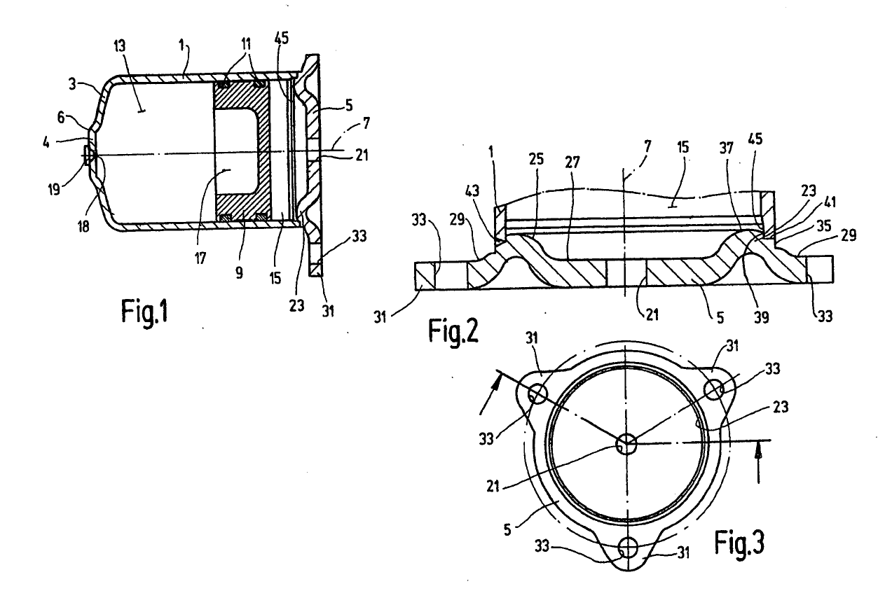

FIG. 1 presents a longitudinal section of the exemplary embodiment of the hydraulic accumulator claimed for the invention in the form of a piston-type accumulator;

FIG. 2 a partial longitudinal section on a scale larger than that of FIG. 1 exclusively of an end area of the exemplary embodiment in which the tube forming the accumulator housing is sealed by a cover-like sealing component;

FIG. 3 an end view of the exemplary embodiment drawn on the scale of FIG. 1, as seen from above the cover-like sealing component.

In FIG. 1, which shows an exemplary embodiment of the hydraulic accumulator claimed for the invention in the form of a piston-type accumulator, a cylindrical metal tube comprising the main component of the accumulator housing is identified by the numeral 1. At the end on the left side in the figure the tube 1 is sealed by an end component 3 integral with the jacket of the tube. This end component 3 is configured by thermal deformation of the respective end section of the tube 1, for example, by a deformation process known as rolling. At the opposite end the tube 1 forming the accumulator housing is sealed so as to be fluid-tight by a cover-like sealing component, in this example in the form of a plate 5.

In the accumulator housing as thus sealed there is a piston 9 displaceable in relation to a longitudinal housing axis 7, the circumference of which piston is hermetically sealed off from the interior wall of the housing by sealing elements 11. The piston 9 thus forms a movable separating element on both sides between adjoining pressure compartments 13 and 15. In order to configure the volume of the pressure compartment 13 to be as large as possible, this being advantageous if the hydraulic accumulator has been designed as a hydropneumatic accumulator as in the exemplary embodiment illustrated and the pressure compartment 13 has been provided for receiving a charge of a pressure gas, the piston 9 has an interior trough 17 concentric with the axis 7. A pressure gas connection with an opening 18 centrally positioned on the end component 3 if the housing, the opening 18 being closed by a sealing component 19, makes it possible to fill the pressure compartment 13 with an appropriate pressure gas, that is, nitrogen gas for hydraulic applications. A connection opening 21 is positioned in the plate 5 so as to be concentric with the longitudinal axis 7.

As is to be seen the most clearly in FIG. 2, the thickness of the material of the plate 5 is significantly greater than the wall thickness of the tube 1 and in the exemplary embodiment illustrated is more than double this wall thickness. In addition, the plate 5 has been molded so that it forms an annular bead 23 concentric with the longitudinal axis 7 and curved to project from the plane of the plate, the portion projecting from the plane of the plate forming a rounded convexity 25. An inner level area 27 surrounded by the annular bead 23 is obtained on the plate 5 from the convexity forming the annular bead 23, as well a level area 29 positioned radially outside the annular bead 23. As is to be seen in FIG. 2, the curvature is designed so that the radius of curvature in the areas of transition to the level areas 27 and 29 is larger than in the area forming the top of the annular bead 23.

In the case of the curvature of the plate 5 executed in this manner, preferably by cold molding, the thickness of the material of the plate 5 remains unchanged in the level areas 27 and 29 adjoining the annular bead 23 on both sides, while a slight decrease in the thickness of the material exclusively inside the annular bead 23 results from tensioning of the material. The connection opening 21 concentric with the longitudinal axis 7 is accordingly positioned in an area in which the thickness of the material is not reduced by deformation of the plate, and this is found to be advantageous for mounting connection fittings. If, as in the exemplary embodiment illustrated, in the level area 29 positioned radially outside the annular bead 23, the plate 5 has extensions 31 forming parts of a flange for fastening the hydraulic accumulator, the circumstance that the thickness of the material remains unchanged in the level area 29 having extensions 31, is also a great advantage, since the full cross-section of the material is available on the fastening openings 33 of the flange components.

As is to be seen the most clearly in FIG. 2, connection of the end edge of the tube 1 and the plate 5 is effected on a support surface of the plate 5 positioned on the radially exterior flank 35 of the convexity 25 of the annular bead 23, so that the top 37 of the bead projects into the interior of the tube 1. As is to be seen in FIG. 2 at the connection point situated on the right, the bearing surface has on the annular bead 23 two surface components extending more or less at a right angle to each other, an annular surface 39 projecting axially into the interior of the tube 1 and an annular surface 41 having an extension in the radial direction. Consequently, a positive locking support of the wall of the tube from radial forces and a positive locking from axial forces on the annular surface 41 are obtained for the tube 1 on the annular surface 39 on the annular bead 23 of the plate 5. The positive locking thus formed, in conjunction with the reinforcing Acorrugation@ which the annular bead 23 represents, results in an optimal force flow for introduction of the forces acting on the connection point between tube 1 and plate 5, so that high stability of shape is achieved with low requirements for material thickness.

FIG. 2 illustrates, on the connection point positioned on the left in the figure between tube 1 and plate 5, a weld seam connection 43, which is configured as preferred type of fastening in the transitional area of annular surfaces 39 and 41, which surfaces consequently are not visible at the connection point positioned on the left in FIG. 2.

As is also to be seen the most clearly in FIG. 2, the interior wall of the tube 1 has in the end edge area a chamfer 45 reducing the wall thickness of the tube 1 in individual areas in the direction of the end edge. This chamfer 45 makes room for the flank component projecting into the interior of the tube 1 on the top 37 of the annular bead 23 by way of which top the tube 1 is as it were slipped on by its end edge.

As has already been pointed out, the closure of the accumulator housing positioned on the left in FIG. 1 is in the form of an end component 3 which forms an integral part of the tube 1 made by hot shaping, a process known as Arolling, @ for example. In the case of the hydraulic accumulator claimed for the invention the end component 3 is shaped by formation of a slightly projecting dome 4 having curved flanks 6 in the central area surrounding the longitudinal axis 7. As is to be seen in FIG. 1, the flanks 6 form on the exterior a concavity on which there is positioned a central component, more or less level, concentric with the longitudinal axis 7, in the center of which component there is a filling opening 18 for charging the pressure compartment 13 with compressed gas, a sealing component 19 being provided on the opening 18.

The curved configuration of the dome 4 acts as a stiffening element on the end component 3, so that stability of shape of the accumulator housing is achieved despite the light construction.

1. A hydraulic accumulator having an accumulator housing in the form of a tube (1) in which a separating element movable along the longitudinal axis (7) of such tube (1), preferably a separating piston (9), separates adjacent pressure compartments (13, 15) from each other on both sides and in which the tube (1) is sealed at least one end by a cover-like sealing component (5) having a bearing surface for connection to the respective end edge of the tube (1), characterized in that the bearing surface has a surface component in the form of an annular surface (39) projecting axially into the interior of the tube (1) for positive-locking support of the tube wall against radial forces and an annular surface (41) extending in the radial direction for positive-locking support of the tube wall against axial forces.

2. A hydraulic accumulator having an accumulator housing in the form of a tube (1) in which a separating element movable along the longitudinal axis (7) of such tube (1), preferably a separating piston (9), separates adjacent pressure compartments (13, 15) from each other on both sides and in which the tube (1) is sealed at one end by an end component (3) shaped by hot forming from the wall of the tube (1), characterized in that a curved dome (4) is formed on the end component (3) an area adjacent to and concentric with the longitudinal axis (7) for formation of an elevation of the end component (3).

3. The hydraulic accumulator as claimed in claim 1, wherein the sealing component is in the form of a plate (5) having a deformation in the form of an annular bead (23) which extends into the interior of the tube (1) and which is provided on the radially exterior flank (35) of its projecting convexity (25) with annular surfaces (39, 41) forming the bearing surface.

4. The hydraulic accumulator as claimed in claim 3, wherein the wall of the tube (1) is designed in the interior in the area adjoining the end edge with a camfer (45) so that the wall thickness of the tube (1) is reduced locally on the end edge, at least in the area which surrounds the top (37) of the annular bead (23).

5. The hydraulic accumulator as claimed in claim 3, wherein the annular bead (23) is configured by cold molding on the plate (5) forming the sealing component.

6. The hydraulic accumulator as claimed in claim 3, wherein the plate (5) forming the sealing component is connected to the tube (1) by a weld connection (43) configured on the bearing surface.

7. The hydraulic accumulator as claimed in claim 3, wherein the plate (5) has at least in individual areas over the circumference of the tube (1) radially projecting extensions (31) which form at least parts of a fastening flange having fastening openings (33).

8. The hydraulic accumulator as claimed in claim 7, wherein extensions (31) mounted at regular angular distances from each other are provided for the formation of at least two, preferably three, flange components.

9. The hydraulic accumulator as claimed in claim 5, wherein the annular bead (23) of the plate (5) is curved outward by cold extrusion molding from the plane of the plate (5) so that the thickness of the material of the plate (5) is greater in the level areas (27, 29) adjoining the annular bead (23) than in the curved area.

10. The hydraulic accumulator as claimed in claim 9, wherein a connection opening (21) is provided in the center of the plate (5) having the full thickness of the material.

11. The hydraulic accumulator as claimed in claim 9, wherein the radius of curvature of the curve is greater in the areas of transition to the level areas (27, 29) of the plate (5) than in the area forming the top (37) of the annular bead (23).

12. The hydraulic accumulator as claimed in claim 2, wherein the flanks (6) of the dome (4) projecting from the end component (3) are concave in shape on the exterior.

13. The hydraulic accumulator as claimed in claim 12, wherein the dome (4) has a filling opening (18) concentric with the longitudinal axis (7) of the tube (1).
